(19) United States
(12) Patent Application Publication
(10) Pub. No.: US 2003/0216900 A1
(43) Pub. Date: Nov. 20, 2003

(54) Method and system for calculating the electrostatic force due to a system of charged bodies in molecular modeling

(75) Inventor: Dan E. Rosenthal, Los Altos, CA (US)

Correspondence Address: RITTER, LANG & KAPLAN, 12930 SARATOGA AE. SUITE D1, SARATOGA, CA, 95070, US

(73) Assignee: Protein Mechanics, Inc., Mountain View, CA

(21) Appl. No.: 10/371,978

(22) Filed: Feb. 21, 2003

Related U.S. Application Data
(60) Provisional application No. 60/358,657, filed on Feb. 21, 2002.

(51) Int. Cl. G06G 7/58; G06G 7/48

(52) U.S. Cl. 703/11

(57) ABSTRACT

In the molecular modeling of a molecular system represented by constituent charged rigid bodies, the electrostatic interactions are computed between the rigid bodies, rather than the individual atoms which constitute the bodies. Multipole representations of the charge distribution of the bodies are used, and the total translational force and moment acting on each rigid body are computed using approximations of the form:

$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2} .$$

When the approximations are applied to small or medium-sized molecules, such as biomolecules of current interest such as proteins, the electrostatic force computations according to the approximations of the present invention are faster than the direct or fast multipole methods.

### CROSS-REFERENCES TO RELATED APPLICATIONS

This application claims the benefit of the priority filing date of Provisional Patent Application No. 60/358,657, filed Feb. 21, 2002, which is hereby incorporated by reference.

### BACKGROUND OF THE INVENTION

The present invention is related to the field of molecular modeling and, in particular, to the calculations of electrostatic forces for the effective computer simulation of the behavior of molecules and of the properties of a molecule or systems of interacting molecules in solution. The invention aids computations that exploit molecular mechanics models and time integration to determine the simulated behavior and properties of molecules.

The motions of bodies in molecular mechanics are determined by Newton's Laws of Motion. Among the calculations required for the simulation of the motion of molecular bodies include electrostatic interactions, which are defined by Coulomb's law, i.e., the force between two charges is directly proportional to the product of the charges and is inversely proportional to the square of the distance between the charges. Electrostatic force calculations dominate force determinations in molecules because electrostatic forces are long-range and occur between all pairs of atoms.

Heretofore, conventional molecular dynamics (MD) has adopted an atom-by-atom approach for the simulation of biomolecules. The determination of forces have been directed those acting on individual atoms. This approach is most evident in the “direct” methods for calculations of electrostatic interactions. If there are n atoms in the molecule, then the calculations for the electrostatic forces between the atoms of the molecule are of the order O(n²). Such direct methods for electrostatic force calculations are expensive in computer time and scale poorly as the molecular system and the number of constituent atoms grows. To reduce the cost of the force computations, prior efforts have used approximations, which include the truncation of the force for the atomic pair whose separation exceeds a specified cutoff distance. However, such truncation of the force introduces undesirable artifacts into the simulations.

Another approach is the “fast multipole” methods which are advantageous for very large molecular systems. These methods compute electrostatic forces to within a desired accuracy and, unlike the truncation of the direct methods, become more accurate as the separation between atoms increases. Recent efforts have shown that calculations with these methods are of asymptotic order O(n log n), or even O(n) as the number of atoms n increases. However, these methods become effective after the molecular system includes several thousand atoms, e.g., a molecule formed by over 10,000 atoms, and have been developed and applied only to systems of particles.

Thus current methods to calculate molecular electrostatic forces leave much to be desired. Direct methods are only useful for very small systems, while fast multipole methods are practical only for very large systems.

A promising approach to molecular mechanics and dynamics which greatly improves computational speeds has been to use interacting rigid bodies to approximate various parts of a given molecule. This recent development discretizes in certain situations a molecule, particularly a biomolecule, into groups of rigid bodies and applies multibody dynamics techniques to determine the behavior of the molecule by computer. Different aspects of this development in molecular mechanics and dynamics are described in U.S. application Ser. No. 10/053,253, filed Nov. 2, 2001 and entitled, “METHOD FOR LARGE TIMESTEPS IN MOLECULAR MODELING”; U.S. application Ser. No. 10/053,354, filed Nov. 2, 2001 and entitled, “METHOD FOR RESIDUAL FORM IN MOLECULAR MODELING”; and U.S. application Ser. No. 10/053,348, filed Nov. 2, 2001 and entitled, “METHOD FOR ANALYTICAL JACOBIAN COMPUTATION IN MOLECULAR MODELING”; all of which are assigned to the present assignee and are herewith incorporated by reference for all purposes.

Present fast multipole methods have not been developed and applied to such advantageous rigid body techniques in molecular mechanics. The fast multipole methods require as-yet undeveloped adaptive, hierarchical techniques to maintain accuracy and to achieve their stated bound when applied to highly spatially inhomogeneous systems, such as molecular systems modeled by rigid bodies. Furthermore, these methods have been developed for molecular systems having very large numbers of atoms, thus excluding certain biomolecules of interest having an “intermediate” size, such as proteins, and the like.

Hence there is a need for the efficient calculation of molecular electrostatic forces which matches and is adapted to the emerging technology of rigid body molecular mechanics. Indeed, one of the goals of rigid body molecular mechanics has been toward the rapid computer calculation of the behavior of molecules over time. Dawdling calculations of the electrostatic force component for the equations of motion retard the calculations of the equations of the motion and the timely determination of the behavior of the subject molecule is impeded. To counter this bottleneck, the present invention provides for the fast and efficient determination of the electrostatic forces in molecules of particularly interest in the biotechnology field.

### SUMMARY OF THE INVENTION

For the computer modeling and simulation of the behavior of molecular systems, the present invention provides for a method of computing the electrostatic interactions within a molecular system which is represented by a plurality of rigid bodies, each having a distribution of electric charges. Where the rigid bodies are sufficient separated from each other, the charge distribution for each rigid body is approximated as an expansion of multipoles, and the electrostatic interactions between one of the rigid bodies and the other rigid bodies of the molecular system is calculated by the expansions of the multipoles of the selected one and remainder of the plurality of rigid bodies to obtain the total force, the translation force and rotational moment, upon the one rigid body. For optimal computation, the molecular system has less than 10,000 atoms.

The present invention provides that the approximations of the electrostatic force be of the form:

$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2}$$

where \tilde{F}₂ and \tilde{M}₂ represent the translational force and rotational moment respectively; q₂, p₂, \hat{Q}₂ and Ô₂ represent selected multipole expansion terms respectively for a charge distribution of a selected one rigid body; and

$${u}_{3 \times 1} , {M}_{3 \times 3} , {N}_{3 \times 5} and {T}_{3 \times 10}$$

represent selected multipole expansion terms for the sum of electric fields from the remainder of the rigid bodies having at least a predetermined separation from the selected one rigid body. Where a pair of rigid bodies are not spaced from each other for the approximations to be sufficiently accurate, the direct method of using the Coulomb force between charges distributed in the two bodies are used to determine the electrostatic force.

The present invention provides for a method calculating the electrostatic interactions within a molecular system with the molecular system represented as a plurality of rigid bodies each having a distribution of electric charges. The method has the steps of defining a boundary for each of the rigid bodies; approximating a distribution of electric charges as an expansion of electric multipoles to a selected degree for each of the rigid bodies; selecting one of rigid bodies; determining a separation between the selected rigid body and each of the remainder of rigid bodies; and calculating the approximated electrostatic interactions between the selected rigid body and each of the remainder of rigid bodies having at least a predetermined separation from the selected rigid body with respect to the defined boundaries of the selected rigid body and each of the remainder of rigid bodies. The approximated electrostatic interactions of the form given above. To determine the total approximated electrostatic interactions, the method also has the step of summing the approximated electrostatic interactions.

Where the selected rigid body and any rigid body from the remainder of rigid bodies are too close for the approximated electrostatic interactions to be accurate, the method provides for calculating direct electrostatic interactions between the selected rigid body and the remainder rigid body. The direct electrostatic interactions is generated from the Coulomb force between charges in the charge distribution of the selected rigid body and the remainder rigid body. The method also provides for summing the direct electrostatic interactions between the selected rigid body and each of the remainder rigid bodies having a separation from the selected rigid body less than a predetermined amount for the approximated electrostatic interactions to be accurate.

To determine the total electrostatic interaction upon the selected rigid body by the remainder of rigid bodies, the method further has the step of summing the summed approximated electrostatic interactions and the summed direct electrostatic interactions. To determine the total of electrostatic interactions within the molecular system, the steps of selecting, calculating approximate electrostatic interactions, summing approximate electrostatic interactions; calculating direct electrostatic interactions, summing direct electrostatic interactions, are repeated for all of the rigid bodies.

The present invention also provides for a computer system and computer code for calculating the electrostatic interactions of a molecular system represented by constituent rigid bodies.

### BRIEF DESCRIPTION OF THE DRAWINGS

FIG. 1 shows two exemplary rigid bodies and reference systems to explain the electrostatic interactions between the charges on the bodies and effects on the bodies;

FIG. 2 shows two exemplary rigid bodies in the form of charged rods to illustrate the accuracy of the approximations of the present invention;

FIG. 3A shows two exemplary rigid bodies in the form of crossed dipoles to illustrate the accuracy of the approximations of the present invention; FIG. 3B is a log-log plot of the moment error versus separation for this example; FIG. 3C is a plot of the relative error versus separation for this example;

FIG. 4 shows two exemplary rigid bodies, each with six charged atoms, to further illustrate the accuracy of the approximations of the present invention;

FIGS. 5A and 5B illustrate a flow chart of steps of one approximation method to determine the electrostatic interactions in which method the receiver body and source body terms are separated, according to the present invention;

FIG. 6 is a table of computational times of a direct method and approximation methods MP1 and MP2 to compare the computational efficacy of the different methods; and

FIG. 7 illustrates the general organization of a computer system which could be instructed to calculate the electrostatic interactions of a molecular system, according to the present invention.

### DESCRIPTION OF THE SPECIFIC EMBODIMENTS

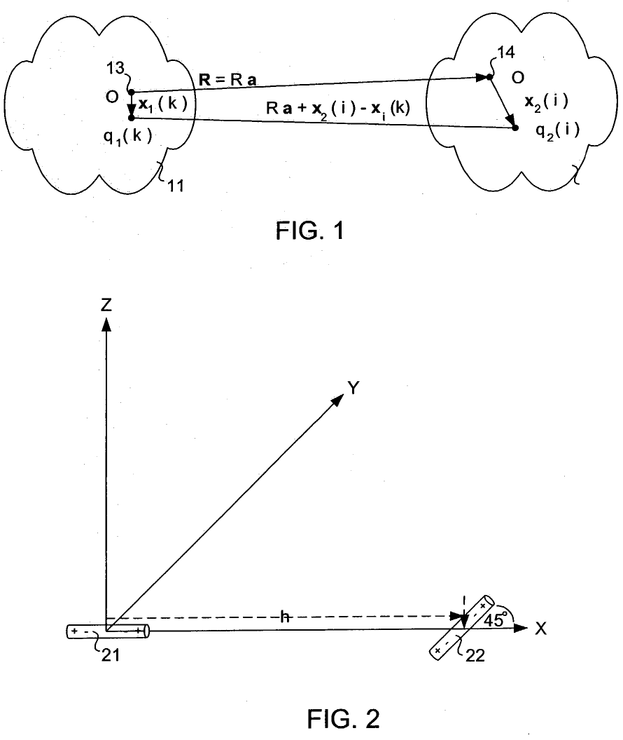

Molecular mechanics and simulation methods require the calculation of the total force, the translational and rotational components, acting on each physical unit of a molecular system. For the present invention the physical unit is a rigid body formed by constituent atoms. To better explain the approximations of the present invention, the exact electrostatic force and moment on a body are explained with reference to FIG. 1 in which two exemplary rigid bodies 11 and 12 carry fixed sets of electric charges, n₁ for number of charges belonging to the body 11 and n₂ for the number of charges belonging to the body 12. For purposes of this explanation, the “receiver” body 12 is the body subject to a force and moment due to the electric field of the “source” body 11.

R is the displacement of the origin 14 of body 12 relative to the origin 13 of the body 11. The convention of using bolded fonts to indicate nonscalar quantities is followed. The magnitude of R is given by R. The unit vector a is parallel to the vector R; hence R=Ra. In the following equations, a subscript 2 denotes a quantity related to the body 12, while a subscript 1 denotes a quantity related to the body 11. For example, q₂(i) is the ith charge of the body 12 and is located at the location x₂ (i) with respect to the origin 14 of the body 12. F₂(i), the total electrostatic force exerted on q₂ (i) by the atoms of the 11 is given by Coulomb's law as:

$${F}_{2} ( i ) = {q}_{2} ( i ) {\sum }_{k = 1}^{{n}_{2}} \frac{{q}_{1} ( k ) ( Ra + {x}_{2} ( i ) - {x}_{1} ( k ) )}{{( Ra + {x}_{2} ( i ) - {x}_{1} ( k ) )}^{3 / 2}}$$

and F₂, the total electrostatic force exerted on the body 12 by the body 11 is:

$${F}_{2} = {\sum }_{i = 1}^{{n}_{1}} {F}_{2} ( i )$$

M₂, the total moment exerted on the origin 14 of the body 12 by the body 11 is given by:

$${M}_{2} = {\sum }_{i = 1}^{{n}_{1}} {x}_{2} ( i ) \times {F}_{2} ( i )$$

Multipole Approximations

In accordance with the present invention, the approximations of the electrostatic translational and rotational forces, given exactly as F₂ and M₂ respectively in the example above, are expressed in terms of multipole moments which characterize the charge distribution on a body. Parenthetically, the terms, multipole(s) or multipole moment(s), are used herein to include monopole(s), i.e., charges, unless the language is explicitly contrary to this usage. Hence the multipole moments, a collection of constants, for a charge distribution on a body are, for the first few moments, as follows:

Total Charge q:

$$q = {\sum }_{i = 1}^{natoms} {q}_{i}$$

Dipole Moment p:

$$p = {\sum }_{i = 1}^{natoms} {q}_{i} {x}_{i}$$

Quadrupole Moment Q:

$$Q = \sum {q}_{i} ( 3 {x}_{i} {x}_{i}^{′} - {x}_{i}^{2} E )$$

The quadrupole moment is a symmetric, traceless, second order vector. It has five associated scalars and may displayed as:

$$Q = [ \begin{matrix}2 {x}^{2} - {y}^{2} - {z}^{2} & 3 xy & 3 xz \\ 3 xy & - {x}^{2} + 2 {y}^{2} - {z}^{2} & 3 yz \\ 3 xz & 3 yz & - {x}^{2} - {y}^{2} + 2 {z}^{2}\end{matrix} ]$$

Octopole Moment O: O, the octopole moment is a third order tensor. In general, such an object can have 27 scalar components. It turns out that the octopole moment actually has only has ten distinct scalars: (For the sake of clarity, summation signs have been omitted in the following.)

cubic elements;

second degree elements;

first degree elements.

The octopole moment can be visualized has a hypermatrix with three “sheets”. If X is defined as the matrix,

$$[ \begin{matrix}{x}_{1}^{2} & {x}_{1} {x}_{2} & {x}_{1} {x}_{3} \\ {x}_{1} {x}_{2} & {x}_{2}^{2} & {x}_{2} {x}_{3} \\ {x}_{1} {x}_{3} & {x}_{2} {x}_{3} & {x}_{3}^{2}\end{matrix} ] ,$$

the sheets of the octopole moment are x₁X, x₂X, and x₃X. Thus, an operation such as a·O means (a·x)X (a matrix), and a·O·a (a vector) means (a·x)(X·a)=(a·x)²x. In particular, e₁·O=x₁X, etc., so that e₁·O·e₁+e₂·O·e₂+e₃·O·e₃=(x₁²+x₂²+x₃²)x. These results are used in the approximations below.

Of course, the charge distribution on a body may be characterized with greater accuracy by adding even higher order terms, but for the purposes of this description the charge distribution terminates with the octopole.

Electrostatic Force Approximations

Using the multipole approximations of the charge distributions of the bodies 11 and 12 of FIG. 1, the translational force F₂ on the body 12 at its origin is approximated by \tilde{F}₂:

\tilde{F}₂=F_{charge-charge}+F_{charge-dipole}+F_{dipole-dipole}+F_{dipole-quadrapole},

where

$${F}_{char ge - charge} = \frac{1}{{R}^{2}} {q}_{1} {q}_{2} a ;$$

$${F}_{char ge - dipole} = \frac{1}{{R}^{3}} {q}_{1} ( {p}_{2} - 3 a ( a \cdot {p}_{2} ) ) - \frac{1}{{R}^{3}} {q}_{2} ( {p}_{1} - 3 a ( a \cdot {P}_{1} ) ) ;$$

$$\begin{matrix}{F}_{dipole - dipole} = \frac{1}{{R}^{4}} ( 3 {p}_{1} ( a \cdot {p}_{2} ) + 3 a ( {p}_{1} \cdot {p}_{2} ) + 3 {p}_{2} ( a \cdot {p}_{1} ) ) - \\ \frac{15}{{R}^{4}} a ( a \cdot {p}_{1} ) ( a \cdot {p}_{2} ) ; \end{matrix}$$

$$and$$

$$\begin{matrix}{F}_{charge - quadrapole} = \frac{5 a}{2 {R}^{4}} ( {q}_{1} a \cdot {Q}_{2} \cdot a + {q}_{2} a \cdot {Q}_{1} \cdot a ) - \\ \frac{1}{{R}^{4}} ( {q}_{1} {Q}_{2} \cdot a + {q}_{2} {Q}_{1} \cdot a ) .\end{matrix}$$

As stated previously, the subscripts “1” and “2” refer to the bodies 11 and 12 respectively. The validity of the above approximation for F₂ is described in the Appendix below.

\tilde{F}₂ is a “consistent” expansion of F₂, i.e., all the terms of a given order have been included. Thus the leading term in the expansion of the error, F₂−\tilde{F}₂, is O(1/R⁵) and a log plot of the error versus the separation between the bodies does indeed have a slope of −5 as discussed below.

Likewise, the rotation force or moment M₂ on the body 12 about its origin is approximated by \tilde{M}₂:

\tilde{M}₂=M_{charge-dipole}+M_{dipole-dipole}+M_{charge-quadrapole}+M_{dipole-quadrapole}+M_{charge-octopole}

where

$${\tilde{M}}_{charge - dipole} = \frac{1}{{R}_{2}} {q}_{1} {p}_{2} \times a ;$$

$${\tilde{M}}_{dipole - dipole} = \frac{1}{{R}^{3}} ( 3 ( a \cdot {p}_{1} ) {p}_{2} \times a + {p}_{1} \times {p}_{2} ) ;$$

$${\tilde{M}}_{charge - quadrapole} = \frac{{q}_{1}}{{R}^{3}} a \times {Q}_{2} \cdot a ;$$

$$\begin{matrix}{\tilde{M}}_{dipole - quadapole} = \frac{5}{{R}^{4}} ( ( a \cdot {p}_{1} ) a \times {Q}_{2} \cdot a ) + \\ \frac{1}{{R}^{4}} ( {p}_{2} \times {Q}_{2} \cdot a - a \times {Q}_{2} \cdot {p}_{1} ) + \\ \frac{1}{{R}^{4}} ( \frac{5}{2} {p}_{2} \times a ( a \cdot {Q}_{1} \cdot a ) - {p}_{2} \times {Q}_{1} \cdot a ) ;\end{matrix}$$

$$\begin{matrix}{\tilde{M}}_{charge - octopole} = \frac{3 {q}_{1}}{2 {R}^{4}} ( a \times ( {e}_{1} \cdot O \cdot {e}_{1} + {e}_{2} \cdot O \cdot {e}_{2} + {e}_{3} \cdot O \cdot {e}_{3} ) ) - \\ \frac{15 {q}_{1}}{2 {R}^{4}} a \times ( a \cdot O \cdot a ) .\end{matrix}$$

The validity of the above approximation for M₂ is also described in the Appendix.

To simply the multipole formulas above, the center of charge in a body is selected as its origin. This choice makes its dipole vector p equal to zero, and thus eliminates all the dipole interactions. The dipole can be made zero whenever the body has a net charge by choosing the proper point as the origin. If the body has no net charge, then it usually has a non-zero dipole vector, independent of the choice of origin. Of course, an uncharged body can be treated as two overlapping bodies, one carrying all the positive charges, the other carrying all the negative charges. The dipole moment for each body can then be made to vanish. Thus dipole moment terms can be discarded from the approximation formulas above. Many terms are eliminated and calculations are greatly simplified.

Accuracy of Approximations

While the error, i.e., the difference between an exact force and its approximation above, falls at a certain rate with respect to the body separation, the force approximations are used at finite body separations. The accuracy of the approximations for separations which are most likely to occur in the molecular mechanics and simulations should be determined. For an understanding of the approximations and their efficacy, some simple examples are set forth below.

FIG. 2 illustrates an example for the electrostatic interactions between two charged rods. Each body is a rod having a length of two units with five alternating positive and negative charges. The source rod 21 is centered at the origin and lies along the X-axis. The receiver rod 22 is displaced h units along the X-axis and is tilted 45° from the X-axis. When h=5, the exact displacement force F₂₂ and the approximate displacement force \tilde{F}₂₂ on the receiver rod 22 due to the source rod 21 are:

$${F}_{22} = [ \begin{matrix}- 0.05024892086518 \\ 0.00633002612597 \\ 0\end{matrix} ] , while$$

$${\tilde{F}}_{22} = [ \begin{matrix}- 0.04900000000000 \\ 0.00360000000000 \\ 0\end{matrix} ]$$

The force is not directed along the X-axis, even though the displacement is. The finite extend of the two bodies give rise to a significant force component in the Y-direction. Note the each body 21 and 22 has either three positive charges and two negative charges, or three negative charges and two positive charges, for a net charge of plus one or minus one. Therefore the charge-charge interaction is simply −1/R², directed along the X-axis. When h=5, this term in the force is −0.04, so that the other terms in the approximation are definitely important for this relatively close approach of the two bodies. When the two bodies 21 and 22 are further separated, say, h=10,

$${F}_{22} = [ \begin{matrix}- 0.01058451326587 \\ 0.00026176136907 \\ 0\end{matrix} ] , while$$

$${\tilde{F}}_{22} = [ \begin{matrix}- 0.01056250000000 \\ 0.00022500000000 \\ 0\end{matrix} ]$$

The force is more nearly expressed by the charge-charge interaction at this larger separation. Varying the separation, the relative error becomes less than 1% whenever the separation exceeds 8 units. This is compared to the unit size of the bodies.

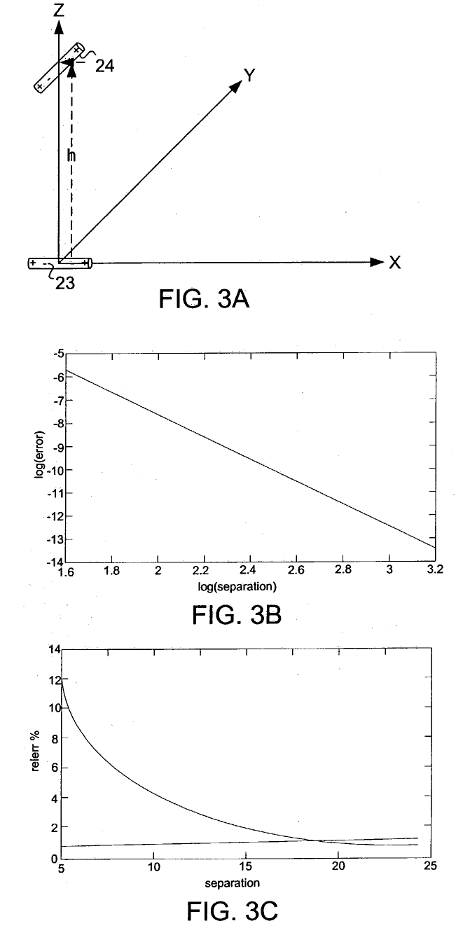

FIG. 3A illustrates another example with crossed dipole bodies. The source body 23 consists of a positive charge at location (1,0,0) and a negative charge at (−1,0,0). The receiver body 24 consists of a positive charge at location (0,1,h) and a negative charge at (0,−1,h). Viewed from above the Z-axis the two bodies 23 and 24 form a cross. In this case, the approximate force \tilde{F}₂₄ yields the exact result—that there is no net force on the receiver body 24 because the forces cancel in pairs. There is however, a moment about the Z-axis. FIG. 3B shows the error in the moment, i.e., \tilde{M}₂₄−M₂₄, exerted on the receiver body 24. The plot illustrates the convergence of the approximation to the actual moment as separation increases; the error falls as the inverse fifth power of the separation, i.e., 1/R⁵.

A best fit line for the moment error, (the normalized absolute error) yields 1n(err)=2.34−4.95*1n(separation), from which err≅10/h⁵. Of course, the separation by itself can be misleading. Notice that each dipole can be enclosed by a unit sphere so that the separation is really relative to the maximum size of either multipole collection. Also, in this case each body 23 and 24 has no net charge. As described previously, the dipole contributions could have been eliminated by splitting each body into a positive and negative charge. This reduces to a direct computation, taking this extra step would have produced exact results, but would not have exercised any terms except charge-charge interactions. The relative error shown in FIG. 3C is less than 1% when the separation h exceeds 17.

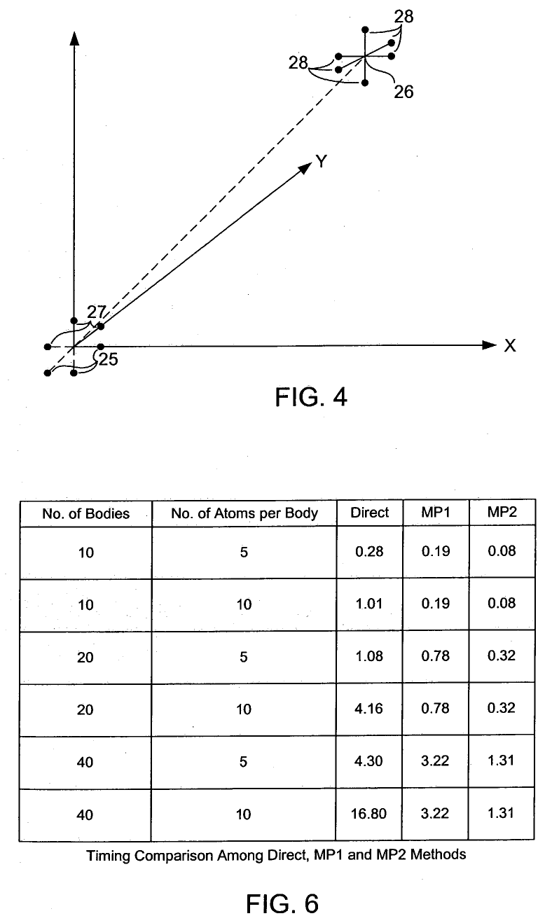

Finally, a more general example is given. In this example, illustrated by FIG. 4, each body 25 and 26 consists of six atoms 27 and 28 for the bodies 25 and 26 respectively, each atom placed one unit along the positive and negative directions of each coordinate axis. The reference numbers 25 and 26 indicate the center of each body. The charges of the atoms are randomly assigned. The receiver body 26 is displaced in the (1,1,1) direction. In this example, the absolute error is err=0.5/R⁵. The relative error is less than 1% when the separation exceeds h=5. It is less than 0.1% when the separation exceeds 10. Again, it should be noted the separation is relative to the size of the multipoles, which are of unit size in this example. Furthermore, this example illustrate the typical results of the approximate formulas. While the error in this case is still O(1/R⁵), removal of the dipoles greatly reduces the error constant while simultaneously speeding computation.

Generalization of Approximations

The approximation formulas for \tilde{F}₂ and \tilde{M}₂ represent the displacement force and rotational moment arising out of the electrostatic interactions between two rigid bodies. In a collection of bodies in a molecular system, there are different ways to compute the total electrostatic force acting on each body due to all the other bodies. Assuming that the distances between the bodies are sufficiently large, a straightforward way is to determine the forces between all pairs of bodies by the approximation formulas. The force on each body, the receiver body in the terms of the previous descriptions, is the sum of the forces due to each of the other bodies, the source bodies. This is the approach of the method termed MP1 (MultiPole1) with respect to the table in FIG. 6 discussed below.

Rather than simply summing the forces, an alternative approach is to first sum the electric fields generated by the source bodies for a receiver body and then evaluate the action of the composite field upon the receiver body to find the electrostatic force acting on the body. With this approach, termed MP2 (MultiPole2) with respect to the table in FIG. 6, general expressions for the approximated translational and rotational forces on each body can be found in which the receiver and source body terms are separated based on the observation that every term in the approximation formulas involves a source term interacting with a receiver term through some geometry factor. Although expressed using vector-tensor techniques, every term is bilinear in the source-receiver multipoles. For example, there is no case in which the receiver charge is squared, or the source charge and the source dipole appears together, and so forth. The data for each receiver body can be “vectorized” by constructing \hat{Q}₂, a five-vector for the quadrupole moments, and Ô₂, a ten-vector for the octopole moments from the charge distribution of the receiver body. \tilde{F}₂ and \tilde{M}₂ for each body then have the form:

$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2}$$

where the coefficients, u, M, N and T, in the equation depend only upon the other bodies, i.e., the source bodies, and their geometries in the molecular system. Using this equation to express the electrostatic interactions allows the summation of the matrix coefficients to determine u, N, M, and T for the receiver body. It should be noted that the receiver body has different coefficients, u, M, N and T, for \tilde{F}₂ and \tilde{M}₂ respectively. Then the force upon the receiver body, i.e., \tilde{F}₂ and \tilde{M}₂, is determined by multiplication by the appropriate coefficients with the receiver body constants, q₂, p₂, \hat{Q}₂ and Ô₂, of which q₂ and p₂ are quantities often used in the field of electrostatics. The other quantities, \hat{Q}₂ and Ô₂, are less often encountered and for the present invention are: \hat{Q}₂=[Q₁ Q₂ Q₃ Q₄ Q₅]; where

$${Q}_{1} = {\sum }_{i = 1}^{natoms} {q}_{i} ( 2 {x}_{i}^{2} - {y}_{i}^{2} - {z}_{i}^{2} ) ;$$

$${Q}_{2} = {\sum }_{i = 1}^{natoms} {q}_{i} ( 3 {x}_{i} {y}_{i} ) ;$$

$${Q}_{3} = {\sum }_{i = 1}^{natoms} {q}_{i} ( 3 {x}_{i} {z}_{i} ) ;$$

$${Q}_{4} = {\sum }_{i = 1}^{natoms} {q}_{i} ( - {x}_{i}^{2} + 2 {y}_{i}^{2} - {z}_{i}^{2} ) ;$$

$${Q}_{5} = {\sum }_{i = 1}^{natoms} {q}_{i} ( 3 {y}_{i} {z}_{i} ) ;$$

and

Ô₂=[O₁ O₂ O₃ O₄ O₅ O₆ O₇ O₈ O₉ O₁₀]; where

$${O}_{1} = {\sum }_{i = 1}^{natoms} {q}_{i} ( {x}_{i}^{3} ) ;$$

$${O}_{2} = {\sum }_{i = 1}^{natoms} {q}_{i} ( {y}_{i}^{3} ) ;$$

$${O}_{3} = {\sum }_{i = 1}^{natoms} {q}_{i} ( {z}_{i}^{3} ) ;$$

$${O}_{4} = {\sum }_{i = 1}^{natoms} {q}_{i} ( {x}_{i}^{2} {y}_{i} ) ;$$

$${O}_{5} = {\sum }_{i = 1}^{natoms} {q}_{i} ( {x}_{i}^{2} {z}_{i} ) ;$$

$${O}_{6} = {\sum }_{i = 1}^{natoms} {q}_{i} ( {y}_{i}^{2} {x}_{i} ) ;$$

$${O}_{7} = {\sum }_{i = 1}^{natoms} {q}_{i} ( {y}_{i}^{2} {z}_{i} ) ;$$

$${O}_{8} = {\sum }_{i = 1}^{natoms} {q}_{i} ( {z}_{i}^{2} {x}_{i} ) ;$$

$${O}_{9} = {\sum }_{i = 1}^{natoms} {q}_{i} ( {z}_{i}^{2} {y}_{i} ) ; and$$

$${O}_{10} = {\sum }_{i = 1}^{natoms} {q}_{i} ( {x}_{i} {y}_{i} {z}_{i} ) .$$

where xᵢ, yᵢ and zᵢ are the Cartesian coordinates of i^{th} charge qᵢ with respect to a selected reference point for the receiver body.

Generating the coefficients in this form for \tilde{F}₂ and \tilde{M}₂ each, is straightforward. For the approximated translational force, \tilde{F}₂:

$$u = \frac{{q}_{1}}{{R}^{2}} a - \frac{1}{{R}^{3}} ( {p}_{1} - 3 a ( a \cdot {p}_{1} ) ) + \frac{5 a}{2 {R}^{4}} a \cdot {Q}_{1} \cdot a + \frac{1}{{R}^{4}} {Q}_{1} \cdot a$$

$$M = \frac{{q}_{1}}{{R}^{3}} ( \underline{\underline{E}} - 3 aa ) + \frac{3}{{R}^{4}} ( {p}_{1} a + {ap}_{1} + a \cdot {p}_{1} \underline{\underline{E}} + 5 aa ( a \cdot {p}_{1} ) )$$

$$\begin{matrix}N = \frac{5 {q}_{1}}{{R}^{4}} [ \begin{matrix}{a}_{1} \\ {a}_{2} \\ {a}_{3}\end{matrix} ] [ ( {a}_{1}^{2} - {a}_{3}^{2} ) 2 {a}_{1} {a}_{2} 2 {a}_{1} {a}_{3} ( {a}_{2}^{2} - {a}_{3}^{2} ) 2 {a}_{2} {a}_{3} ] - \\ \frac{{q}_{1}}{{R}^{4}} [ \begin{matrix}{a}_{1} & {a}_{2} & {a}_{3} & 0 & 0 \\ 0 & {a}_{1} & 0 & {a}_{2} & {a}_{3} \\ - {a}_{1} & 0 & {a}_{1} & - {a}_{1} & {a}_{2}\end{matrix} ]\end{matrix}$$

where for a source body, R is the separation between the receiver body and the source body: q₁ is the total charge, p₁ is the dipole moment, and Q₁ is the quadrupole moment of the source body. As before, a is a unit vector with coordinate representation (a₁, a₂, a₃) directed from a reference point of source body to a reference point of the receiver body; R is the distance between the reference points; and E is the identity matrix. The coefficient T is not used in the calculation for \tilde{F}₂.

For \tilde{M}₂, the approximated rotational moment on said selected one rigid body:

u=0;

$$M = \frac{1}{{R}^{3}} ( {\tilde{p}}_{1} - 3 ( a \cdot {p}_{1} ) \tilde{a} ) + \frac{1}{{R}^{4}} ( {Q}_{1} \tilde{\cdot } a - \frac{5}{2} ( a \cdot {Q}_{1} \cdot a ) \tilde{a} ) ;$$

$$\begin{matrix}N = ( \frac{{q}_{1}}{{R}^{3}} + ( \frac{5 ( a \cdot {p}_{1} )}{{R}^{4}} ) ) \\ [ \begin{matrix}- {a}_{2} {a}_{3} & - {a}_{3} {a}_{1} & {a}_{2} {a}_{1} & - 2 {a}_{2} {a}_{3} & {a}_{2}^{2} - {a}_{3}^{2} \\ 2 {a}_{3} {a}_{1} & {a}_{2} {a}_{3} & {a}_{3}^{2} - {a}_{1}^{2} & {a}_{3} {a}_{1} & - {a}_{2} {a}_{1} \\ - {a}_{2} {a}_{1} & {a}_{1}^{2} - {a}_{2}^{2} & - {a}_{2} {a}_{3} & {a}_{2} {a}_{1} & {a}_{3} {a}_{1}\end{matrix} ] - \\ \frac{1}{{R}^{4}} \\ [ \begin{matrix}( - {p}_{y} {a}_{3} + {a}_{2} {p}_{z} ) & ( - {p}_{z} {a}_{1} + {a}_{3} {p}_{x} ) & ( {p}_{y} {a}_{1} - {a}_{2} {p}_{x} ) & 0 & 0 \\ 0 & ( - {p}_{y} {a}_{3} + {a}_{2} {p}_{z} ) & 0 & ( - {p}_{z} {a}_{1} + {a}_{3} {p}_{x} ) & ( {p}_{y} {a}_{1} - {a}_{2} {p}_{x} ) \\ ( - {p}_{y} {a}_{1} + {a}_{2} {p}_{x} ) & 0 & ( - {p}_{y} {a}_{3} + {a}_{2} {p}_{z} ) & ( - {p}_{y} {a}_{1} + {a}_{2} {p}_{x} ) & ( - {p}_{z} {a}_{1} + {a}_{3} {p}_{x} )\end{matrix} ]\end{matrix}$$

$$and$$

$$\begin{matrix}T = \frac{3 {q}_{1}}{2 {R}^{4}} [ \begin{matrix}0 & - {a}_{3} & {a}_{2} & - {a}_{3} & {a}_{2} & 0 & {a}_{2} & 0 & - {a}_{3} & 0 \\ {a}_{3} & 0 & - {a}_{1} & 0 & - {a}_{1} & {a}_{3} & - {a}_{1} & {a}_{3} & 0 & 0 \\ - {a}_{2} & {a}_{1} & 0 & {a}_{1} & 0 & - {a}_{2} & 0 & - {a}_{2} & {a}_{1} & 0\end{matrix} ] - \\ \frac{15 {q}_{1}}{2 {R}^{4}} [ \begin{matrix}{a}_{1} {a}_{1} & 0 & 0 & 2 {a}_{1} {a}_{2} & 2 {a}_{1} {a}_{3} & {a}_{2} {a}_{2} & 0 & {a}_{3} {a}_{3} & 0 & 2 {a}_{2} {a}_{3} \\ 0 & {a}_{2} {a}_{2} & 0 & {a}_{1} {a}_{1} & 0 & 2 {a}_{1} {a}_{2} & 2 {a}_{2} {a}_{3} & 0 & {a}_{3} {a}_{3} & 2 {a}_{1} {a}_{3} \\ 0 & 0 & {a}_{3} {a}_{3} & 0 & {a}_{1} {a}_{1} & 0 & {a}_{2} {a}_{2} & 2 {a}_{1} {a}_{3} & 2 {a}_{2} {a}_{3} & 2 {a}_{1} {a}_{2}\end{matrix} ]\end{matrix}$$

where a tilde over a vector turns it into a cross-product matrix. For vector p₁=(pₓ, p_{y}, p_{z}):

$$\begin{matrix} & {\tilde{p}}_{1} = [ \begin{matrix}0 & - {p}_{z} & {p}_{y} \\ {p}_{z} & 0 & - {p}_{x} \\ - {p}_{y} & {p}_{x} & 0\end{matrix} ] \\ Likewise \tilde{a} is & \\ & \tilde{a} = [ \begin{matrix}0 & - {a}_{3} & {a}_{2} \\ {a}_{3} & 0 & - {a}_{1} \\ - {a}_{2} & {a}_{1} & 0\end{matrix} ]\end{matrix}$$

This has the effect that ã·v where v is any vector, is equal to the cross-product a×v. The expression Q₁\tilde{·}a means to form the product Q₁·a (a vector) and apply the tilde to the result. This is then equal to (Q₁·a)×v for any vector v.

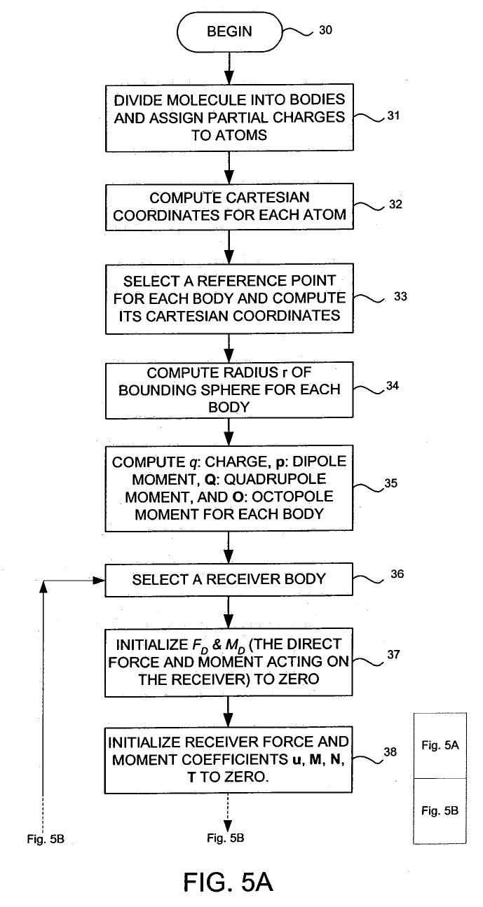

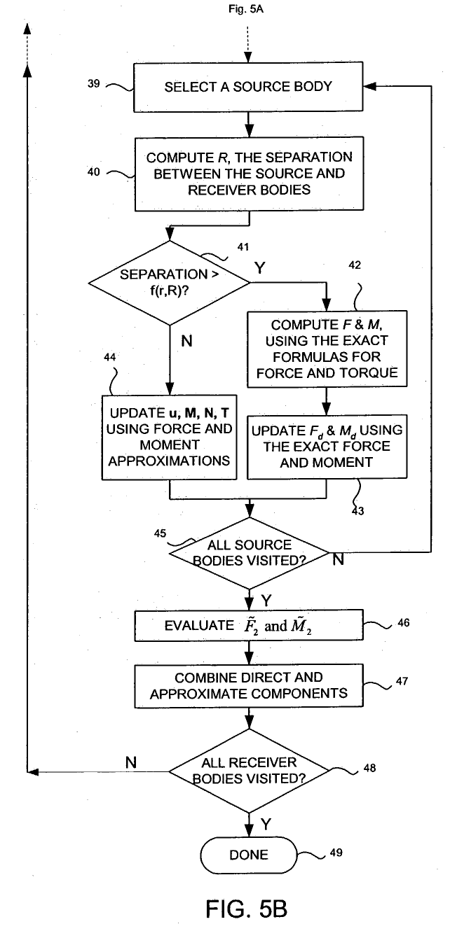

Multipole method MP2 is illustrated by the flow chart of steps in FIGS. 5A and 5B. It should be noted that MP2 does not necessarily rely on the multipole approximations completely; the method also uses direct methods partially to calculate the force and moment on a receiver body when a source body is too close for the approximations to be accurate, i.e., the Coulomb forces between charges in the receiver and source bodies are calculated in place of multipole calculations when the separation between the two bodies are less than a predetermined amount. MP2 begins with a customary initial step 30, after which the molecule, or molecular system, in question is divided by operation step 31 into bodies. Each body consists of a set of atoms, with a given partial charge on each atom. In next step 32 the Cartesian coordinates are computed for each atom; and then by step 33 a reference point is selected for each body and the Cartesian coordinates for each body's reference point is computed. Note the discussion above on the selection of the reference point for a body with respect to its dipole moment p. A radius r of a bounding sphere for each body is computed in step 34. As used in later steps of MP2, the radius r provides a criterion for judging whether the distance between two bodies is sufficiently large to permit the use of the approximation formulas; otherwise, direct methods are used. Then for each body in the system, the charge q, the dipole moment p, the quadrupole moment Q, and the octopole moment O, the formulas of which are given above are computed in step 35. These quantities are determined with respect to each body's reference point.

A receiver body is then selected in step 36 and F_{D} and M_{D}, the direct force and moment respectively acting on the receiver body are initialized to zero in step 37. The direct force and moment will be computed by considering the near neighbors of the receiver body; i.e., the bodies which are too close to the receiver body for the approximations to be effective. In step 38 the coefficients u, M, N, T for the receiver are also initialized to zero. Again, note that there are two sets of such coefficients, one set for the force and another set for the moment acting on the receiver.

Then a source body is selected in step 39 and R, the separation between the source and receiver bodies, is computed in step 40. In step 41, a comparison is made between the radius r of bounding sphere for either source or receiver, and the R, the separation between the source and receiver. If the separation is too small compared to the bounding sphere for either source or receiver, then the process proceeds to step 42 by which F and M are computed using the exact formulas for force and torque, and F_{D} and M_{D} are updated using the exact force and moment in step 43. If, on the other hand, the separation is not too small by decision step 41, then the approximation formulas are used in step 44 and the coefficients u,M,N,T for force and moment approximations are updated. The formulas are given above for a single-source-receiver pair and the process moves to decision step 45 which has one branch loop back to step 39 to ensure that these calculations are performed for all the source bodies with respect to the selected receiver body.

After considering all source bodies, a second branch from the decision step 45 leads to step 46 in which the components of the approximate force and moment, \tilde{F}₂ and \tilde{M}₂, using the given formulas are evaluated. By step 47 the direct and approximate components of force and moment for the selected receiver body are combined, i.e.,:

F₂=\tilde{F}₂+F_{D}

M₂=\tilde{M}₂+M_{D}

For the total force and moment, the force and moments on all the bodies must be considered. This is handled by the loop in decision step 48. If all the bodies of the molecule or molecular system have not been selected as a receiver, the process branches back to step 36 and another molecular body is selected as a receiver. If all the bodies of the molecule or molecular system have been selected as receiver bodies, the process ends (step 49). The loop created by step 48 to select different molecular bodies as receivers and the nested loop created by step 45 to select all the remaining molecular bodies as sources once a receiver is selected, calculate the total electrostatic interaction, lateral force and rotational moment, of the molecule or molecular system in question.

Though the determination of \hat{Q}₂ and Ô₂, and the source body coefficients u, M, N and T for \tilde{F}₂ and \tilde{M}₂ for each receiver body is time-consuming, this particular approach is believed to be ultimately faster than the straightforward approach of simply summing the forces to determine the total of the electrostatic interactions in a molecular system of any complexity.

The table of FIG. 6 compares the computational efficacy among the direct method and the two approximation methods MP1 and MP2 for the calculation of the total electrostatic interaction of a hypothetical molecular system. Different number of bodies, nbod, are tested with different number of atoms in each body, natoms/bod. From the tabulated results, it is observed the direct method is not sensitive to the number of bodies in the system, as might be expected. On the other hand, the approximation methods, which are based on rigid bodies, are only sensitive to the number of bodies. The computational cost of the MP methods is quadratic in the number N of bodies, rather than the number n of atoms. Thus, the MP methods share some features of the direct method in that interactions are computed pairwise, and also some features of the multipole methods, in that groups of atoms are treated by computing their aggregate effect. Furthermore, the table suggests that the MP2 approach is computationally more efficient than MP1, especially as the molecular system grows larger.

If the number of atoms per body is very small, it is hard to compute the electrostatic force faster than can be done by a direct method. The MP2 method especially occupies a middle ground computationally between the direct and fast multipole methods. It is not as good for large systems as the fast multipole methods, but it is always be better than a direct method for large and medium size molecular systems. The approximate formulas allow the advantageous molecular modeling of molecules of less than 10,000 atoms. At the lower limit, the approximate formulas work well with molecules containing as few as 50 atoms, such as proteins. For such molecules, a speed-up is provided of at least a factor of three, and in some cases, a factor of more than 10 in the electrostatic force computation, compared to a direct method.

Hence the molecular modeling of a molecular system of intermediate size, say, less than 10,000 atoms and greater than 50 atoms, with constituent parts act as rigid bodies, benefits greatly from the approximations of the present invention. The electrostatic force acting on each body is expressed in terms of direct multipole interactions between the rigid bodies, without requiring specific knowledge of each body's atomic constitution. In addition. these methods can serve as a starting point for other electrostatic calculations which include polarization effects.

Although the multipole expansions of the present invention are approximate, the approximations can be adapted to achieve a specified accuracy, either by incorporating more terms into the multipole expansions, or by increasing the separation between bodies when applying the formulas. In the examples above, simple charges are localized at atom centers. More generally, the present invention can be used for the more elaborate cases in which the charge distributions are represented in more sophisticated ways, for example, as a set of monopole, dipole, and quadrupole charges at each atom, or by polarizable charges which can change dynamically, or by combinations of multipole and polarizable representations. The present invention provides a means by which these individual charge entities may be combined using efficient pre-computation of net effects over entire rigid bodies. Intra-and inter-molecular electrostatic interactions can then be performed on a per-rigid body basis, rather than per-atom. Furthermore, molecular modeling can be performed with implicit solvent models by modifying the electrostatic potentials calculated with the approximations of the present invention.

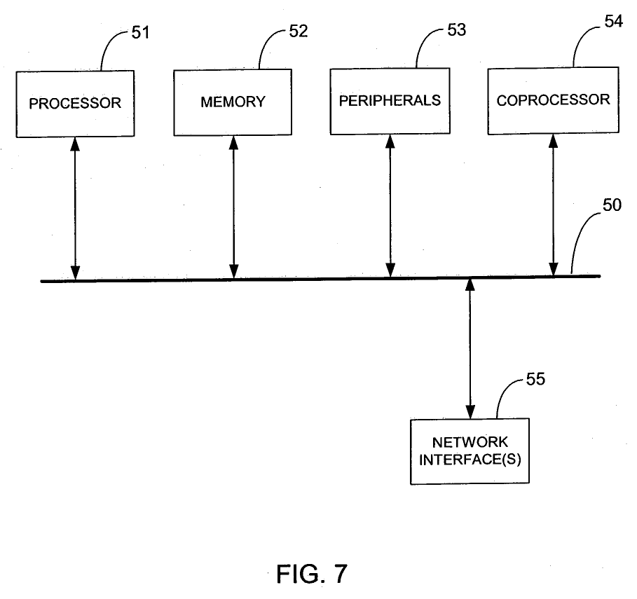

To carry out the calculations described above, a computer system is used with at least one processor and associated memory subsystem for holding the computer code to instruct the processor to perform the operations described above. FIG. 7 illustrates the basic architecture of such a computer system having a processor 51, a memory subsystem 52, peripherals 53 such as input/output devices (keyboard, mouse, display, etc.), perhaps a co-processor 54 to aid in the computations, and network interface devices 55, all interconnected by a bus 50. The memory subsystem optimally includes, in increasing order of access latency, cache memory, main memory and permanent storage memory, such as hard disk drives. Given the amount of intensity of computation, it should be understood that the computer system could include multiple processors with multiple associated memory subsystems to perform the computations in parallel; or, rather than having the various computer elements connected by a bus in conventional computer architecture as illustrated by FIG. 7, the computer system might formed by multiple processors and multiple memory subsystems interconnected by a network.

Therefore, while the foregoing is a complete description of the embodiments of the invention, it should be evident that various modifications, alternatives and equivalents may be made and used. For example, while the description above has been related, for the most part, to biomolecules, the present invention is applicable to any molecular system which can be separated into, and represented by, constituent rigid bodies, and which is large enough to render direct methods of calculating the electrostatic force inefficient, and small enough to render fast multipole methods ineffective. Accordingly, the above description should not be taken as limiting the scope of the invention which is defined by the metes and bounds of the appended claims.

[image]

[image]

[image]

[image]

What is claimed is:

1. A method of calculating the electrostatic interactions within a molecular system, said molecular system represented as a plurality of rigid bodies each having a distribution of electric charges, comprising
approximating said charge distribution of each rigid body as an expansion of electric multipoles to a selected degree; and
calculating an electrostatic force upon a selected one of said plurality of rigid bodies due to a remainder of said plurality of rigid bodies of said molecular system by said expansions of said multipole charges of said selected one and remainder of said plurality of rigid bodies by:
determining selected multipole expansion terms for a charge distribution of said selected one rigid body;
determining selected multipole expansion terms for a sum of electric fields at said selected one rigid body due to distributions of charge of said remainder of said rigid bodies, each having at least a predetermined separation from said one rigid body;
multiplying said selected multipole expansion terms for said charge distribution of said selected one rigid body and said selected multipole expansion terms for said sum of electric fields due to distributions of charge of said remainder of said rigid bodies to generate products of selected multipole expansion terms of said selected one rigid body and of said remainder of said rigid bodies; and
summing said products of said selected multipole expansion terms for said electrostatic force upon said selected one rigid body.

2. The method of claim 1 wherein said electrostatic force comprises translational force and rotational moment upon said selected one rigid body.

3. The method of claim 2 wherein said electrostatic force is of the form:
$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2}$$
where \tilde{F}₂ and \tilde{M}₂ represent said translational force and rotational moment respectively; q₂, p₂, \hat{Q}₂ and Ô₂ represent selected multipole expansion terms respectively for a charge distribution of said selected one rigid body; and
$${u}_{3 \times 1} , {M}_{3 \times 3} , {N}_{3 \times 5} and {T}_{3 \times 10}$$
represent selected multipole expansion terms for said sum of electric fields from said remainder of said rigid bodies having at least a predetermined separation from said selected one rigid body.

4. The method of claim 3 wherein in said approximating step, said charge distribution of each rigid body is expanded up to octopoles.

5. The method of claim 3 wherein for said selected one rigid body, q₂ represent the total charge, p₂ represents the dipole moment, \hat{Q}₂ represents a five-vector of quadrupole moments and Ô₂ a ten-vector of octopole moments.

6. The method of claim 5 wherein
\hat{Q}₂=[Q₁ Q₂ Q₃ Q₄ Q₅ ]; where
$$\begin{matrix}{Q}_{1} = {\sum }_{i = 1}^{natoms} {q}_{i} ( 2 {x}_{i}^{2} - {y}_{i}^{2} - {z}_{i}^{2} ) ; \\ {Q}_{2} = {\sum }_{i = 1}^{natoms} {q}_{i} ( 3 {x}_{i} {y}_{i} ) ; \\ {Q}_{3} = {\sum }_{i = 1}^{natoms} {q}_{i} ( 3 {x}_{i} {z}_{i} ) ; \\ {Q}_{4} = {\sum }_{i = 1}^{natoms} {q}_{i} ( - {x}_{i}^{2} + 2 {y}_{i}^{2} - {z}_{i}^{2} ) ; \\ {Q}_{5} = {\sum }_{i = 1}^{natoms} {q}_{i} ( 3 {y}_{i} {z}_{i} ) ;\end{matrix}$$
and
Ô₂=[O₁ O₂ O₃ O₄ O₅ O₆ O₇ O₈ O₉ O₁₀]; where
$$\begin{matrix}{O}_{1} = {\sum }_{i = 1}^{natoms} {q}_{i} ( {x}_{i}^{3} ) ; \\ {O}_{2} = {\sum }_{i = 1}^{natoms} {q}_{i} ( {y}_{i}^{3} ) ; \\ {O}_{3} = {\sum }_{i = 1}^{natoms} {q}_{i} ( {z}_{i}^{3} ) ; \\ {O}_{4} = {\sum }_{i = 1}^{natoms} {q}_{i} ( {x}_{i}^{2} {y}_{i} ) ; \\ {O}_{5} = {\sum }_{i = 1}^{natoms} {q}_{i} ( {x}_{i}^{2} {z}_{i} ) ; \\ {O}_{6} = {\sum }_{i = 1}^{natoms} {q}_{i} ( {y}_{i}^{2} {x}_{i} ) ; \\ {O}_{7} = {\sum }_{i = 1}^{natoms} {q}_{i} ( {y}_{i}^{2} {z}_{i} ) ; \\ {O}_{8} = {\sum }_{i = 1}^{natoms} {q}_{i} ( {z}_{i}^{2} {x}_{i} ) ; \\ {O}_{9} = {\sum }_{i = 1}^{natoms} {q}_{i} ( {z}_{i}^{2} {y}_{i} ) ; and \\ {O}_{10} = {\sum }_{i = 1}^{natoms} {q}_{i} ( {x}_{i} {y}_{i} {z}_{i} ) .\end{matrix}$$
where xᵢ, yᵢ and zᵢ are the Cartesian coordinates of i^{th} charge qᵢ with respect to a selected reference point for said selected one rigid body.

7. The method of claim 3 wherein for said sum of electric fields at said selected one rigid body due to distributions of charge of said remainder of said rigid bodies having at least a predetermined separation from said selected one rigid body,
$${u}_{3 \times 1} , {M}_{3 \times 3} , {N}_{3 \times 5} , and {T}_{3 \times 10} ,$$
each represent for coefficient quantities for q₂, p₂, \hat{Q}₂ and Ô₂, respectively.

8. The method of claim 7 wherein for \tilde{F}₂, the translational force on said selected one rigid body by one of said remainder of said rigid bodies having at least a predetermined separation from said selected one rigid body:
$$\begin{matrix}u = \frac{{q}_{1}}{{R}^{2}} a - \frac{1}{{R}^{3}} ( {p}_{1} - 3 a ( a \cdot {p}_{1} ) ) + \frac{5 a}{2 {R}^{4}} a \cdot {Q}_{1} \cdot a + \frac{1}{{R}^{4}} {Q}_{1} \cdot a \\ M = \frac{{q}_{1}}{{R}^{3}} ( {E}_{=} - 3 aa ) + \frac{3}{{R}^{4}} ( {p}_{1} a + {ap}_{1} + a \cdot {p}_{1} {E}_{=} + 5 aa ( a \cdot {p}_{1} ) ) \\ \begin{matrix}N = \frac{5 {q}_{1}}{{R}^{4}} [ \begin{matrix}{a}_{1} \\ {a}_{2} \\ {a}_{3}\end{matrix} ] [ \begin{matrix}( {a}_{1}^{2} - {a}_{3}^{2} ) & 2 {a}_{1} {a}_{2} & 2 {a}_{1} {a}_{3} & ( {a}_{2}^{2} - {a}_{3}^{2} ) & 2 {a}_{2} {a}_{3}\end{matrix} ] - \\ \frac{{q}_{1}}{{R}^{4}} [ \begin{matrix}{a}_{1} & {a}_{2} & {a}_{3} & 0 & 0 \\ 0 & {a}_{1} & 0 & {a}_{2} & {a}_{3} \\ - {a}_{1} & 0 & {a}_{1} & - {a}_{1} & {a}_{2}\end{matrix} ]\end{matrix}\end{matrix}$$
where for the selected one rigid body, R is the separation between said selected one rigid body and said one of said remainder of said rigid bodies; q₁ is the total charge, p₁ is the dipole moment, and Q₁, is the quadrupole moment of said one of said remainder of said rigid bodies; and a is a unit vector directed from a reference point of said one of said remainder of said rigid bodies to a reference point of said selected one rigid body with coordinate representation (α₁, α₂, α₃); R is the distance between the reference points and E is the identity matrix.

9. The method of claim 8 wherein said calculating step comprises summing \tilde{F}₂, the translational force on said selected one rigid body by one of said remainder of said rigid bodies, for said remainder of said rigid bodies having at least said predetermined separation from said selected one rigid body.

10. The method of claim 7 wherein for \tilde{M}₂, the rotational moment on said selected one rigid body:
u=0;
$$\begin{matrix}M = \frac{1}{{R}^{3}} ( {\tilde{p}}_{1} - 3 ( a \cdot {p}_{1} ) \tilde{a} ) + \frac{1}{{R}^{4}} ( {Q}_{1} \tilde{\cdot } a - \frac{5}{2} ( a \cdot {Q}_{1} \cdot a ) \tilde{a} ) ; \\ N = ( \frac{{q}_{1}}{{R}^{3}} + \frac{5 ( a \cdot {p}_{1} )}{{R}^{4}} ) [ \begin{matrix}- {a}_{2} {a}_{3} & - {a}_{3} {a}_{1} & {a}_{2} {a}_{1} & - 2 {a}_{2} {a}_{3} & {a}_{2}^{2} - {a}_{3}^{2} \\ 2 {a}_{3} {a}_{1} & {a}_{2} {a}_{3} & {a}_{3}^{2} - {a}_{1}^{2} & {a}_{3} {a}_{1} & - {a}_{2} {a}_{1} \\ - {a}_{2} {a}_{1} & {a}_{1}^{2} - {a}_{2}^{2} & - {a}_{2} {a}_{3} & {a}_{2} {a}_{1} & {a}_{3} {a}_{1}\end{matrix} ] - \\ \frac{1}{{R}^{4}} [ \begin{matrix}( - {p}_{y} {a}_{3} + {a}_{2} {p}_{z} ) & ( - {p}_{z} {a}_{1} + {a}_{3} {p}_{x} ) & ( {p}_{y} {a}_{1} - {a}_{2} {p}_{x} ) & 0 & 0 \\ 0 & ( - {p}_{y} {a}_{3} + {a}_{2} {p}_{z} ) & 0 & ( - {p}_{z} {a}_{1} + {a}_{3} {p}_{x} ) & ( {p}_{y} {a}_{1} - {a}_{2} {p}_{x} ) \\ ( - {p}_{y} {a}_{1} + {a}_{2} {p}_{x} ) & 0 & ( - {p}_{y} {a}_{3} + {a}_{2} {p}_{z} ) & ( - {p}_{y} {a}_{1} + {a}_{2} {p}_{x} ) & ( - {p}_{z} {a}_{1} + {a}_{3} {p}_{x} )\end{matrix} ] \\ and \\ T = \frac{3 {q}_{1}}{2 {R}^{4}} [ \begin{matrix}0 & - {a}_{3} & {a}_{2} & - {a}_{3} & {a}_{2} & 0 & {a}_{2} & 0 & - {a}_{3} & 0 \\ {a}_{3} & 0 & - {a}_{1} & 0 & - {a}_{1} & {a}_{3} & - {a}_{1} & {a}_{3} & 0 & 0 \\ - {a}_{2} & {a}_{1} & 0 & {a}_{1} & 0 & - {a}_{2} & 0 & - {a}_{2} & {a}_{1} & 0\end{matrix} ] - \\ \frac{15 {q}_{1}}{2 {R}^{4}} [ \begin{matrix}{a}_{1} {a}_{1} & 0 & 0 & 2 {a}_{1} {a}_{2} & 2 {a}_{1} {a}_{3} & {a}_{2} {a}_{2} & 0 & {a}_{3} {a}_{3} & 0 & 2 {a}_{2} {a}_{3} \\ 0 & {a}_{2} {a}_{2} & 0 & {a}_{1} {a}_{1} & 0 & 2 {a}_{1} {a}_{2} & 2 {a}_{2} {a}_{3} & 0 & {a}_{3} {a}_{3} & 2 {a}_{1} {a}_{3} \\ 0 & 0 & {a}_{3} {a}_{3} & 0 & {a}_{1} {a}_{1} & 0 & {a}_{2} {a}_{2} & 2 {a}_{1} {a}_{3} & 2 {a}_{2} {a}_{3} & 2 {a}_{1} {a}_{2}\end{matrix} ]\end{matrix}$$

11. The method of claim 10 wherein said calculating step comprises summing \tilde{M}₂, the rotational moment on said selected one rigid body by one of said remainder of said rigid bodies, for said remainder of said rigid bodies having at least said predetermined separation from said selected one rigid body.

12. The method of claim 1 wherein said calculating step is performed upon all of said plurality of rigid bodies to determine a total of said electrostatic interactions within said molecular system.

13. The method of claim 1 wherein electrostatic force calculating step further comprises
calculating directly Coulomb forces between electric charges in said selected one rigid body and in at least one of said remainder of said rigid bodies, said at least one of said remainder of said rigid bodies having a separation less than said predetermined separation from said selected one rigid body.

14. The method of claim 13 wherein said electrostatic force calculating step further comprises calculating directly Coulomb forces between electric charges in said selected rigid body and in each one of said remainder of said rigid bodies having a separation less than said predetermined separation from said selected one rigid body.

15. The method of claim 14 wherein said calculating step is performed upon all of said plurality of rigid bodies to determine a total of said electrostatic interactions within said molecular system.

16. A method of calculating the electrostatic interactions within a molecular system, said molecular system represented as a plurality of rigid bodies each having a distribution of electric charges, comprising
defining a boundary for each of said rigid bodies;
approximating a distribution of electric charges as an expansion of electric multipoles to a selected degree for each of said rigid bodies;
selecting one of said plurality of rigid bodies;
determining a separation between said selected one rigid body and each of the remainder of said rigid bodies;
calculating approximated electrostatic interactions between said selected one of said rigid bodies and each of said remainder of said rigid bodies having at least a predetermined separation from said selected one rigid body with respect to boundaries of said selected rigid body and each of said remainder of said rigid bodies, said approximated electrostatic interactions of the form:
$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2}$$
where \tilde{F}₂ and \tilde{M}₂ represent translational force and rotational moment respectively on said selected one rigid body; q₂, p₂, \hat{Q}₂ and Ô₂ represent selected multipole expansion terms respectively for a charge distribution of said selected one rigid body; and
$${u}_{3 \times 1} , {M}_{3 \times 3} , {N}_{3 \times 5} and {T}_{3 \times 10}$$
represent coefficients for said selected multipole expansion terms from a charge distribution of each of said remainder of said rigid bodies having at least said predetermined separation from said selected one rigid body; and
summing said approximated electrostatic interactions between said selected one of said rigid bodies and each of said remainder of said rigid bodies having at least a predetermined separation from said selected one rigid body.

17. The method of claim 16 further comprising
calculating direct electrostatic interactions between said selected one of said rigid bodies and each of said remainder of said rigid bodies having a separation from said selected one rigid body less than a predetermined amount with respect to boundaries of said selected rigid body and each of said remainder of said rigid bodies, said direct electrostatic interactions generated from the Coulomb force between charges in said charge distribution of said selected one rigid body and each of said remainder of said rigid bodies having a separation from said selected one rigid body less than said predetermined amount; and
summing said direct electrostatic interactions between said selected one of said rigid bodies and each of said remainder of said rigid bodies having a separation from said selected one rigid body less than said predetermined amount.

18. The method of claim 17 further comprising summing said summed approximated electrostatic interactions and said summed direct electrostatic interactions to determine a total electrostatic interaction upon said selected one rigid body by said remainder of said rigid bodies.

19. The method of claim 18 further comprising
repeating said steps of selecting, calculating approximate electrostatic interactions, summing approximate electrostatic interactions; calculating direct electrostatic interactions, summing direct electrostatic interactions, for all of said plurality of rigid bodies to determine a total of said electrostatic interactions within said molecular system.

20. The method of claim 16 wherein in said approximating step, said charge distribution of each rigid body is expanded up to octopoles.

21. The method of claim 16 wherein for said selected one rigid body, q₂ represent the total charge, p₂ represents the dipole moment, \hat{Q}₂ represents a five-vector of quadrupole moments and Ô₂ a ten-vector of octopole moments.

22. The method of claim 21 wherein
\hat{Q}₂=[Q₁ Q₂ Q₃ Q₄ Q₅ ]; where
$$\begin{matrix}{Q}_{1} = {\sum }_{i = 1}^{natoms} {q}_{i} ( 2 {x}_{i}^{2} - {y}_{i}^{2} - {z}_{i}^{2} ) ; \\ {Q}_{2} = {\sum }_{i = 1}^{natoms} {q}_{i} ( 3 {x}_{i} {y}_{i} ) ; \\ {Q}_{3} = {\sum }_{i = 1}^{natoms} {q}_{i} ( 3 {x}_{i} {z}_{i} ) ; \\ {Q}_{4} = {\sum }_{i = 1}^{natoms} {q}_{i} ( - {x}_{i}^{2} + 2 {y}_{i}^{2} - {z}_{i}^{2} ) ; \\ {Q}_{5} = {\sum }_{i = 1}^{natoms} {q}_{i} ( 3 {y}_{i} {z}_{i} ) ;\end{matrix}$$
and
Ô₂=[O₁ O₂ O₃ O₄ O₅ O₆ O₇ O₈ O₉ O₁₀]; where
$$\begin{matrix}{O}_{1} = {\sum }_{i = 1}^{natoms} {q}_{i} ( {x}_{i}^{3} ) ; \\ {O}_{2} = {\sum }_{i = 1}^{natoms} {q}_{i} ( {y}_{i}^{3} ) ; \\ {O}_{3} = {\sum }_{i = 1}^{natoms} {q}_{i} ( {z}_{i}^{3} ) ; \\ {O}_{4} = {\sum }_{i = 1}^{natoms} {q}_{i} ( {x}_{i}^{2} {y}_{i} ) ; \\ {O}_{5} = {\sum }_{i = 1}^{natoms} {q}_{i} ( {x}_{i}^{2} {z}_{i} ) ; \\ {O}_{6} = {\sum }_{i = 1}^{natoms} {q}_{i} ( {y}_{i}^{2} {x}_{i} ) ; \\ {O}_{7} = {\sum }_{i = 1}^{natoms} {q}_{i} ( {y}_{i}^{2} {z}_{i} ) ; \\ {O}_{8} = {\sum }_{i = 1}^{natoms} {q}_{i} ( {z}_{i}^{2} {x}_{i} ) ; \\ {O}_{9} = {\sum }_{i = 1}^{natoms} {q}_{i} ( {z}_{i}^{2} {y}_{i} ) ; and \\ {O}_{10} = {\sum }_{i = 1}^{natoms} {q}_{i} ( {x}_{i} {y}_{i} {z}_{i} ) .\end{matrix}$$
where xᵢ, yᵢ and zᵢ are the Cartesian coordinates of i^{th} charge qᵢ with respect to a selected reference point for said selected one rigid body.

23. The method of claim 22 wherein for \tilde{F}₂:
$$\begin{matrix}u = \frac{{q}_{1}}{{R}^{2}} a - \frac{1}{{R}^{3}} ( {p}_{1} - 3 a ( a \cdot {p}_{1} ) ) + \frac{5 a}{2 {R}^{4}} a \cdot {Q}_{1} \cdot a + \frac{1}{{R}^{4}} {Q}_{1} \cdot a \\ M = \frac{{q}_{1}}{{R}^{3}} ( {E}_{=} - 3 aa ) + \frac{3}{{R}^{4}} ( {p}_{1} a + a {p}_{1} + a \cdot {p}_{1} {E}_{=} + 5 a a ( a \cdot {p}_{1} ) ) \\ N = \frac{5 {q}_{1}}{{R}^{4}} [ \begin{matrix}{a}_{1} \\ {a}_{2} \\ {a}_{3}\end{matrix} ] [ \begin{matrix}( {a}_{1}^{2} - {a}_{3}^{2} ) & 2 {a}_{1} {a}_{2} & 2 {a}_{1} {a}_{3} & ( {a}_{2}^{2} - {a}_{3}^{2} ) & 2 {a}_{2} {a}_{3}\end{matrix} ] - \\ \frac{ {q}_{1} }{{R}^{4}} [ \begin{matrix}{a}_{1} & {a}_{2} & {a}_{3} & 0 & 0 \\ 0 & {a}_{1} & 0 & {a}_{2} & {a}_{3} \\ - {a}_{1} & 0 & {a}_{1} & - {a}_{1} & {a}_{2}\end{matrix} ] \end{matrix}$$
where for the selected one rigid body, R is the separation between said selected one rigid body and said one of said remainder of said rigid bodies; q₁ is the total charge, p₁ is the dipole moment, and Q₁ is the quadrupole moment of said one of said remainder of said rigid bodies;
and a is a unit vector directed from a reference point of said one of said remainder of said rigid bodies to a reference point of said selected one rigid body with coordinate representation (α₁, α₂, α₃); R is the distance between the reference points and E is the identity matrix.

24. The method of claim 22 wherein for \tilde{M}₂:
u=0;
$$\begin{matrix}M = \frac{1}{{R}^{3}} ( {\tilde{p}}_{1} - 3 ( a \cdot {p}_{1} ) \tilde{a} ) + \frac{1}{{R}^{4}} ( {Q}_{1} \tilde{\cdot } a - \frac{5}{2} ( a \cdot {Q}_{1} \cdot a ) \tilde{a} ) ; \\ N = ( \frac{{q}_{1}}{{R}^{3}} + \frac{5 ( a \cdot {p}_{1} )}{{R}^{4}} ) [ \begin{matrix}- {a}_{2} {a}_{3} & - {a}_{3} {a}_{1} & {a}_{2} {a}_{1} & - 2 {a}_{2} {a}_{3} & {a}_{2}^{2} - {a}_{3}^{2} \\ 2 {a}_{3} {a}_{1} & {a}_{2} {a}_{3} & {a}_{3}^{2} - {a}_{1}^{2} & {a}_{3} {a}_{1} & - {a}_{2} {a}_{1} \\ - {a}_{2} {a}_{1} & {a}_{1}^{2} - {a}_{2}^{2} & - {a}_{2} {a}_{3} & {a}_{2} {a}_{1} & {a}_{3} {a}_{1}\end{matrix} ] - \\ \frac{1}{{R}^{4}} [ \begin{matrix}( - {p}_{y} {a}_{3} + {a}_{2} {p}_{z} ) & ( - {p}_{z} {a}_{1} + {a}_{3} {p}_{x} ) & ( - {p}_{y} {a}_{1} - {a}_{2} {p}_{x} ) & 0 & 0 \\ 0 & ( - {p}_{y} {a}_{3} + {a}_{2} {p}_{z} ) & 0 & ( - {p}_{z} {a}_{1} + {a}_{3} {p}_{x} ) & ( - {p}_{y} {a}_{1} - {a}_{2} {p}_{x} ) \\ ( - {p}_{y} {a}_{1} + {a}_{2} {p}_{x} ) & 0 & ( - {p}_{y} {a}_{3} + {a}_{2} {p}_{z} ) & ( - {p}_{y} {a}_{1} + {a}_{2} {p}_{x} ) & ( - {p}_{z} {a}_{1} + {a}_{3} {p}_{x} )\end{matrix} ] and \\ T = \frac{3 {q}_{1}}{2 {R}^{4}} [ \begin{matrix}0 & - {a}_{3} & {a}_{2} & - {a}_{3} & {a}_{2} & 0 & {a}_{2} & 0 & - {a}_{3} & 0 \\ {a}_{3} & 0 & - {a}_{1} & 0 & - {a}_{1} & {a}_{3} & - {a}_{1} & {a}_{3} & 0 & 0 \\ - {a}_{2} & {a}_{1} & 0 & {a}_{1} & 0 & - {a}_{2} & 0 & - {a}_{2} & {a}_{1} & 0\end{matrix} ] - \\ \frac{15 {q}_{1}}{2 {R}^{4}} [ \begin{matrix}{a}_{1} {a}_{1} & 0 & 0 & 2 {a}_{1} {a}_{2} & 2 {a}_{1} {a}_{3} & {a}_{2} {a}_{2} & 0 & {a}_{3} {a}_{3} & 0 & 2 {a}_{2} {a}_{3} \\ 0 & {a}_{2} {a}_{2} & 0 & {a}_{1} {a}_{1} & 0 & 2 {a}_{1} {a}_{2} & 2 {a}_{2} {a}_{3} & 0 & {a}_{3} {a}_{3} & 2 {a}_{1} {a}_{3} \\ 0 & 0 & {a}_{3} {a}_{3} & 0 & {a}_{1} {a}_{1} & 0 & {a}_{2} {a}_{2} & 2 {a}_{1} {a}_{3} & 2 {a}_{2} {a}_{3} & 2 {a}_{1} {a}_{2}\end{matrix} ]\end{matrix}$$

25. A computer system for calculating the electrostatic interactions within a molecular system represented by a plurality of rigid bodies each having a distribution of electric charges, said computer system comprising
at least one processor; and
an associated memory subsystem, said memory subsystem holding computer code to instruct said at least one processor to:
define a boundary for each of said rigid bodies;
approximate a distribution of electric charges as an expansion of electric multipoles to a selected degree for each of said rigid bodies;
select one of said plurality of rigid bodies;
determine a separation between said selected one rigid body and each of the remainder of said rigid bodies;
calculate approximated electrostatic interactions between said selected one of said rigid bodies and each of said remainder of said rigid bodies having at least a predetermined separation from said selected one rigid body with respect to boundaries of said selected rigid body and each of said remainder of said rigid bodies, said approximated electrostatic interactions of the form:
$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2}$$
where \tilde{F}₂ and \tilde{M}₂ represent translational force and rotational moment respectively on said selected one rigid body; q₂, p₂, \hat{Q}₂ and Ô₂ represent selected multipole expansion terms respectively for a charge distribution of said selected one rigid body; and
$${u}_{3 \times 1} , {M}_{3 \times 3} , {N}_{3 \times 5} and {T}_{3 \times 10}$$
represent coefficients for said selected multipole expansion terms from a charge distribution of each of said remainder of said rigid bodies having at least said predetermined separation from said selected one rigid body;
sum said approximated electrostatic interactions between said selected one of said rigid bodies and each of said remainder of said rigid bodies having at least a predetermined separation from said selected one rigid body;
calculate direct electrostatic interactions between said selected one of said rigid bodies and each of said remainder of said rigid bodies having a separation from said selected one rigid body less than a predetermined amount with respect to boundaries of said selected rigid body and each of said remainder of said rigid bodies, said direct electrostatic interactions generated from the Coulomb force between charges in said charge distribution of said selected one rigid body and each of said remainder of said rigid bodies having a separation from said selected one rigid body less than said predetermined amount; and
sum said direct electrostatic interactions between said selected one of said rigid bodies and each of said remainder of said rigid bodies having a separation from said selected one rigid body less than said predetermined amount.

26. The computer system of claim 25 wherein said computer code further instructs said at least one processor to:
sum said summed approximated electrostatic interactions and said summed direct electrostatic interactions to determine a total electrostatic interaction upon said selected one rigid body by said remainder of said rigid bodies.

27. The computer system of claim 26 wherein said computer code further instructs said at least one processor to:
repeat said steps to select, calculate approximate electrostatic interactions, sum approximate electrostatic interactions; calculate direct electrostatic interactions, and sum direct electrostatic interactions, for all of said plurality of rigid bodies to determine a total of said electrostatic interactions within said molecular system.

28. A computer code to instruct a computer system to calculate the electrostatic interactions within a molecular system represented by a plurality of rigid bodies each having a distribution of electric charges, said computer code having the instructions to:
define a boundary for each of said rigid bodies;
approximate a distribution of electric charges as an expansion of electric multipoles to a selected degree for each of said rigid bodies;
select one of said plurality of rigid bodies;
determine a separation between said selected one rigid body and each of the remainder of said rigid bodies;
calculate approximated electrostatic interactions between said selected one of said rigid bodies and each of said remainder of said rigid bodies having at least a predetermined separation from said selected one rigid body with respect to boundaries of said selected rigid body and each of said remainder of said rigid bodies, said approximated electrostatic interactions of the form:
$${\tilde{F}}_{2} , {\tilde{M}}_{2} = {u}_{3 \times 1} {q}_{2} + {M}_{3 \times 3} \cdot {p}_{2} + {N}_{3 \times 5} \cdot {\hat{Q}}_{2} + {T}_{3 \times 10} \cdot {\hat{O}}_{2}$$
where \tilde{F}₂ and \tilde{M}₂ represent translational force and rotational moment respectively on said selected one rigid body; q₂, p₂, \hat{Q}₂ and Ô₂ represent selected multipole expansion terms respectively for a charge distribution of said selected one rigid body; and
$${u}_{3 \times 1} , {M}_{3 \times 3} , {N}_{3 \times 5} and {T}_{3 \times 10}$$
represent coefficients for said selected multipole expansion terms from a charge distribution of each of said remainder of said rigid bodies having at least said predetermined separation from said selected one rigid body;
sum said approximated electrostatic interactions between said selected one of said rigid bodies and each of said remainder of said rigid bodies having at least a predetermined separation from said selected one rigid body;
calculate direct electrostatic interactions between said selected one of said rigid bodies and each of said remainder of said rigid bodies having a separation from said selected one rigid body less than a predetermined amount with respect to boundaries of said selected rigid body and each of said remainder of said rigid bodies, said direct electrostatic interactions generated from the Coulomb force between charges in said charge distribution of said selected one rigid body and each of said remainder of said rigid bodies having a separation from said selected one rigid body less than said predetermined amount; and
sum said direct electrostatic interactions between said selected one of said rigid bodies and each of said remainder of said rigid bodies having a separation from said selected one rigid body less than said predetermined amount.

29. The computer code of claim 28 wherein said computer code further has instruction to:
sum said summed approximated electrostatic interactions and said summed direct electrostatic interactions to determine a total electrostatic interaction upon said selected one rigid body by said remainder of said rigid bodies.

30. The computer code of claim 29 wherein said computer code further has instructions to:
repeat said steps to select, calculate approximate electrostatic interactions, sum approximate electrostatic interactions; calculate direct electrostatic interactions, and sum direct electrostatic interactions, for all of said plurality of rigid bodies to determine a total of said electrostatic interactions within said molecular system.
